(19) United States
(12) Patent Application Publication
(10) Pub. No.: US 2013/0057158 A1
(43) Pub. Date: Mar. 7, 2013

(54) GPS-BASED STREETLIGHT WIRELESS COMMAND AND CONTROL SYSTEM

(71) Applicants: Jack Yitzhak Josefowicz, Halibut Bay (CA); Mark Adam Neary, Mount Uniacke (CA); Qiuning Chen, Halifax (CA)

(72) Inventors: Jack Yitzhak Josefowicz, Halibut Bay (CA); Mark Adam Neary, Mount Uniacke (CA); Qiuning Chen, Halifax (CA)

(73) Assignee: LED ROADWAY LIGHTING LTD., Halifax, NS (CA)

(21) Appl. No.: 13/582,619

(22) PCT Filed: Mar. 1, 2011
(86) PCT No.: PCT/CA2011/000206

§ 371 Date: Nov. 21, 2012

Related U.S. Application Data
(60) Provisional application No. 61/309,395, filed on Mar. 1, 2010.

(51) Int. Cl. H05B 37/02

(52) U.S. Cl. 315/152; 315/312; 315/294

(57) ABSTRACT

A method and apparatus for controlling a streetlight is provided. GPS data is required from a GPS coupled to a process of the streetlight. A geographic location of the streetlight is determined from the received GPS data. A real local time is determined from the GPS data and a sunrise and sunset time associated with the geographic location can then be determined. The on and off state of one or more LED lighting modules of the streetlight can then be controlled upon the determined sunrise and sunset times.

### TECHNICAL FIELD

The present disclosure relates to lighting controls and in particular to exterior or street light controls.

### BACKGROUND

Street lighting typically is isolated operating entities functioning based upon a light sensor. The lighting systems do not provide any means of monitoring, control, or upgradeability. The distribution and location of the system makes controlling lighting systems difficult. Accordingly, systems, device and methods that enable street lighting control remain highly desirable.

### SUMMARY

In accordance with an aspect of the present disclosure there is provided a method for controlling an streetlight comprising acquiring GPS data from a GPS coupled to a process of the streetlight; determining in the processor a geographic location of the street light from the received GPS data; determining in the processor a real local time from the GPS data; determining in the processor a sunrise and sunset time associated with the geographic location; controlling an on and off state of one or more LED lighting modules of the streetlight based upon the determined sunrise and sunset times.

In accordance with another aspect of the present disclosure there is provided a streetlight controller comprising a global positioning system (GPS) dimming module comprising: a GPS receiver; a processor coupled to the GPS receiver for acquiring GPS data from the GPS received determining in a processor a geographic location and a real local time from the GPS data to determine a sunrise and sunset time associated with the geographic location; a LED control interface for controlling a on and off state of one or more LED lighting modules of the streetlight based upon the determined sunrise and sunset times.

### BRIEF DESCRIPTION OF THE DRAWINGS

Further features and advantages of the present disclosure will become apparent from the following detailed description, taken in combination with the appended drawings, in which:

FIG. 1 shows an overall control system block diagram;

FIG. 2 shows GPS system block diagram;

FIG. 3 shows GPS Pre-Programmed Dimming Module architecture;

FIG. 4 shows illustration of streetlight operation based on GPS Pre-Programmed Dimming Module Control Circuit;

FIG. 5a shows a method of streetlight operation using GPS control;

FIG. 5b shows a method of streetlight operation using GPS control with a dimming schedule;

FIG. 6 shows Remote Communication Module Architecture;

FIG. 7 shows Drive-By Wireless Base Station;

FIG. 8 shows Drive-By Wireless Network;

FIG. 9 shows Web-Based Wireless Base Station;

FIG. 10 shows Web-Based Network;

FIG. 11 shows Hand-Held Wireless Base Station;

FIG. 12 shows Hand-Held Wireless Network; and

FIG. 13 is a method of Remote communication.

It will be noted that throughout the appended drawings, like features are identified by like reference numerals.

### DETAILED DESCRIPTION

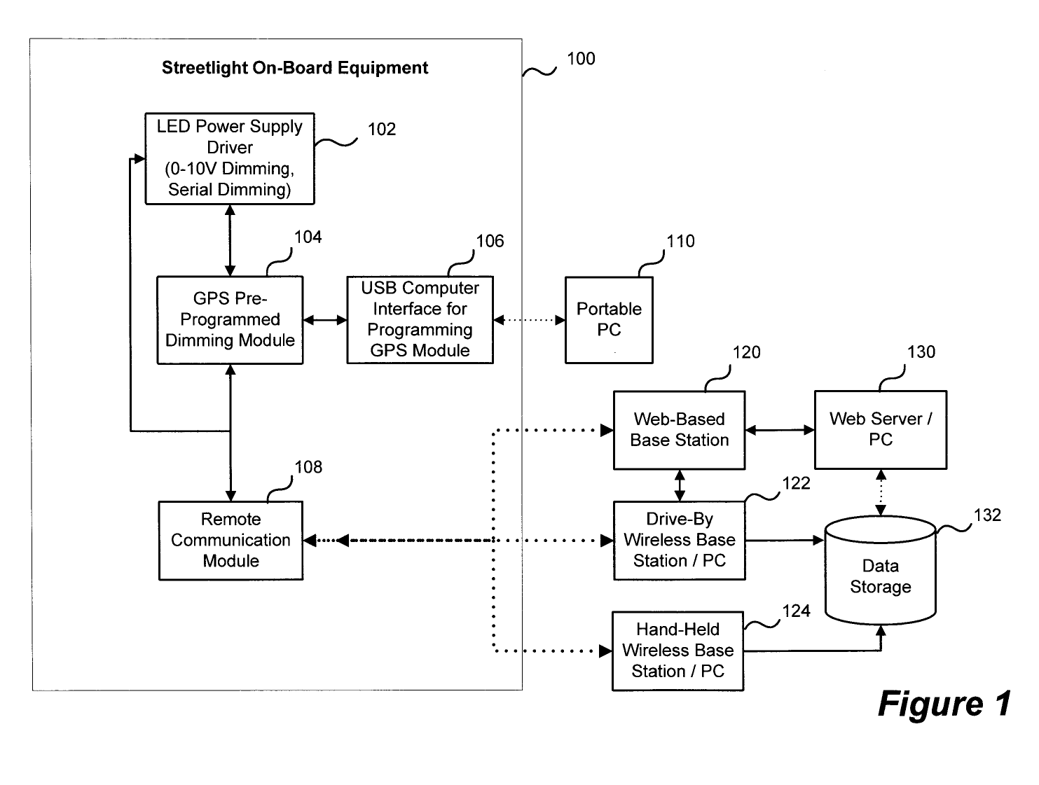

Embodiments are described below, by way of example only, with reference to FIGS. 1-12.

LED street lights offer an opportunity to implement command and control functions that extend the use of the street light beyond the simple lighting of streets and roadways during night-time hours. Since LEDs are normally powered by integrated circuit semiconductor power supplies that provide DC current to the LEDs, power supply drivers can be integrated with digital control electronics that can vary the current to the LEDs, thereby allowing for controlled dimming capabilities. For street lighting, including that which incorporates LED light sources as well as conventional light sources such as high pressure sodium lamps with electronic ballasts, one approach that has been adopted by the lighting industry is to dim the light using an input voltage signal between zero (0) and ten (10) volts. In the standard operation, varying the input voltage signal allows a change in light output in a street light over its entire range of output from zero (0%) to one hundred percent (100%) output. Other dimming interfaces are conceivable.

In this disclosure, streetlight dimming control can be achieved remotely in two ways however the incorporation of a GPS system allows fully autonomous streetlight operation regardless of the nature of other communication and control methodologies. The system described differs fundamentally from other streetlight control systems in that it incorporates a global positioning system (GPS) Pre-Programmed Dimming Module. The GPS Pre-Programmed Dimming Module can work fully autonomously, independent of location, time zone, or the time of year, and it can work in support of another streetlight control system based on wireless communications or power line carrier (PLC) communications.

In the case of a control system that involves only the GPS Pre-Programmed Dimming Module without wireless communication, there is a significant advantage in terms of cost reduction, minimization of system infrastructure, and a simplification that increases system reliability.

In the case of a control system that involves the GPS Pre-Programmed Dimming Module working in conjunction with another communications system, referred to as the as the Remote Communication Module there is an advantage over other commercially available systems in terms of the autonomous operation capability offered by the incorporation of the GPS Pre-Programmed Dimming Module. Specifically, the GPS Pre-Programmed Dimming Module allows other forms of remote communication to be highly intermittent without concerns over autonomous operation of the streetlight control system.

The first dimming control approach, involves the use of a global positioning system (GPS) receiver without the addition of wireless or power line carrier (PLC) system infrastructure. The GPS system providing this capability is referred to as the GPS Pre-Programmed Dimming Module. In this approach, the GPS receiver provides fully autonomous operation of the streetlight, in that complete dimming functionality is realized with no equipment beyond that which is installed in the streetlight. ‘Set it and forget it’ is the straight forward advantage of this approach. The GPS receiver provides an accurate remote method to locate the street light geographically. Furthermore, time of day, day and month are also provided by the GPS system, so that the sunrise and sunset times can be accurately calculated for any street light location. In the calculation of sunrise and sunset times for any streetlight location, the control circuit of the system executes a standard mathematical algorithm that uses geographic position on earth (latitude and longitude) in relation to the location of the sun in space, as well as time and date, as input data for the calculation, and generates the sunrise and sunset times as output data. Such information can be used to turn on, turn off and dim the street light output at predetermined times during the night via a programmed microprocessor. This dimming approach offers a way to reduce energy consumption of the light at night. A microprocessor that can be pre-programmed at the factory, or programmed in the field via a Personal Computer (PC) Universal Serial Bus (USB) interface connection, is used to control time-of-day light output reductions (dimming). This is a particularly attractive approach to furthering energy savings during the night when lower pedestrian and reduced car traffic can justify reductions in light levels, and is one that directly impacts a reduction in electrical energy consumption. The reclassification of streets and roadways to lower light level guidelines during the middle of the night is a trend that is gaining acceptance globally by lighting organizations. The lowering of classifications and its accompanying lower light levels when light output is dimmed results in the reduction in energy consumption. Further, such light output reductions also positively impacts reliability since it improves the life of the electronics and the LEDs, leading to added savings in maintenance costs that can be significantly reduced while saving energy.

The second dimming approach, involves the addition of a communication system, such as wireless radio or power line carrier (PLC), to provide remote control and monitoring capabilities. The communication system providing this capability is referred to as the Remote Communication Module. In this second approach, the GPS Pre-Programmed Dimming Module is included in addition to the Remote Communication Module so that the system described would be considered to be GPS-based.

A diagrammatic representation of the overall GPS-based dimming control system being discussed is shown in the FIG. 1. In FIG. 1, the common aspect of the electronics system is an advanced LED Power Supply Driver 102. The LED Power Supply Driver has a 0-10 volt input, although any voltage range may be utilized, that controls the level of dimming to any desirable light level between 0% and 100% output. It also may include serial communications, advanced diagnostics, monitoring and control capabilities.

The GPS Pre-Programmed Dimming Module 104 can serve as an intelligent, standalone pre-programmable dimming module. Any customer desired dimming scheme can be programmed into a microprocessor at the factory using a communication interface 106 to a computer 110 or programming module.

The Remote Communication Module 108 provides remote communications from a user-operated base station to the LED Power Supply Driver and/or the GPS Pre-Programmed Dimming Module. The data communications capability of the Remote Communication Module 108 may be realized with various wireless radio or power line carrier (PLC) signalling technologies as described below.

As illustrated in FIG. 1, there are several options for the base station that is used to communicate, for the purposes of remote control, with the Remote Communication Module 108. The options are dependent on the type of communications. For example, the Drive-By Wireless Base Station 122 and the Hand-Held Wireless Base Station 124 require the use of some form of wireless signalling technology such as industrial, scientific and medical (ISM) band radio with optional mesh network capability, Bluetooth radio, cellular technology (Code division multiple access (CDMA), Global System for Mobile Communication (GSM), 3G, such as Wi-Max and LTE or 4G etc.), satellite technology (Iridium™ etc.) or Radio Frequency Identification (RFID). This differs from the Web-Based Base Station 120 where the communications may be based on wireless or power line carrier (PLC) signalling technology accessible via a remote web server or PC 130.

Through the use of the system illustrated in FIG. 1, all compatible streetlights within the communication range of the system can be controlled and monitored remotely. Furthermore, if the Remote Communication Module 108 may integrate a watt meter, energy usage may be measured and logged internally to the streetlight. The Remote Communication Module 108 can be used then to access and download recorded energy metering data. For example data from streetlights may be collected and remotely stored and analyzed 132. Similarly, the Remote Communication Module 108 could be used to monitor light functions such as light output power, power supply and LED component temperature, faults of any or all components. Control functions may be implemented such as flashing the LEDs or lighting devices during an accident or other public notice situations.

### GPS Pre-Programmed Dimming Module

The purpose of the GPS Pre-Programmed Dimming Module 104 is to provide a means to control the precise dimming of an individual streetlight that is equipped with the system. The GPS Pre-Programmed Dimming Module may be used to provide complete control of the light output of an appropriately configured streetlight. Alternatively, it may be used in conjunction with another form of streetlight control and monitoring such as a Remote Communication Module 108 as shown in FIG. 1.

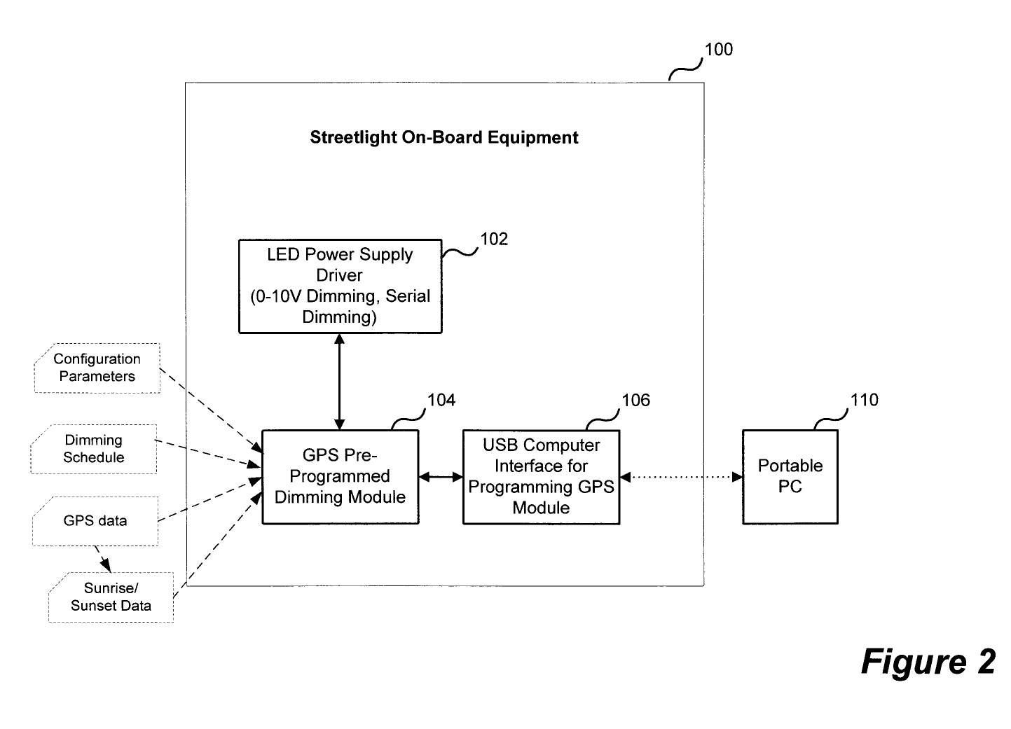

For reference, an illustration of the basic implementation of the GPS Pre-Programmed Dimming Module 104 system is provided as FIG. 2. As illustrated in FIG. 2, the GPS Pre-Programmed Dimming Module 104 is physically connected to the LED Power Supply Driver. The GPS Pre-Programmed Dimming Module 104 exerts control over the LED Power Supply Driver 102 to effect ultimately changes in the light output state of the streetlight. Specifically, the GPS Pre-Programmed Dimming Module 104 generates electrical signals that are interpreted by the electronics of the LED Power Supply Driver 102. The electrical signals may consist of either an analog input voltage, for example, in the range of zero (0) Volts to ten (10) volts, or the signals may consist of serial communications, such as the RS-232 serial communication standard, the I2C (Inter-Integrated Circuit) serial communications standard or the Serial Peripheral Interface Bus (SPI) serial communications standard.

The GPS Pre-Programmed Dimming Module 104 makes use of the data available through the Global Positioning System to control the Turn ON of the streetlight near sunset and to control the Turn OFF of the streetlight near sunrise. With this capability, the streetlight does not need to be fitted with a traditional streetlight Photo Control Switch. Note however, that the system may also be operated with a traditional Photo Control for the purposes of turning the entire streetlight power OFF during daylight hours if it is preferred to use of a Photo Control for this purpose.

The system also uses the GPS to maintain extremely precise real local time within the GPS Pre-Programmed Dimming Module 104 control circuit. With this precise real local time, the GPS Pre-Programmed Dimming Module 104 control circuit can control changes to streetlight output light levels (dimming), and the changes will be very carefully synchronized to real local time.

The system is completely autonomous with the exception that it requires the Global Positioning System (GPS). It is described as a “Set it and forget it” approach to the problem of streetlight dimming control. The Global Positioning System (GPS) is a space-based global navigation satellite system (GNSS). It provides reliable location and time information in all weather conditions, including when the light is covered with snow or ice, and at all times, and anywhere on or near the Earth when and where there is an unobstructed line of sight to four or more GPS satellites. Although the term GPS is utilized in the disclosure any type of global positioning system such as Russian GLObal NAvigation Satellite System (GLONASS), Chinese Compass navigation system or the European Union's Galileo positioning system may be utilized to provide global positioning information.

The operation of the GPS Pre-Programmed Dimming Module 104 is highly flexible and the system may be programmed to execute custom daily dimming schedules based on specific customer requirements. The daily dimming schedules may be reconfigured after the streetlight has been installed in the field through the use of a USB port 336 or another serial communication interface that is accessible on the exterior of the fixture and a Personal Computer (PC) that executes a host reconfiguration software utility. The dimming schedules may be programmed in relation to computed sunrise and sunset schedule from the received GPS data. Additional configuration parameters such as start-up margins or offset or programming for specific dates or occasions may also be accounted for in the dimming schedule.

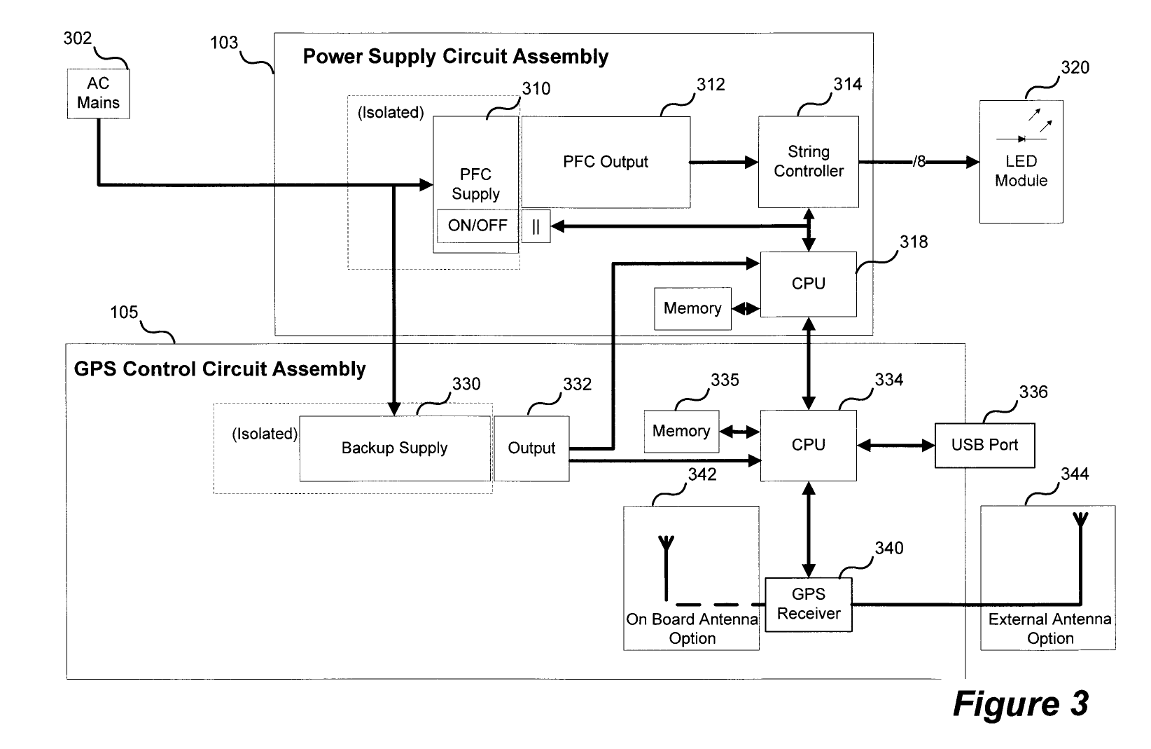

Architecture of the GPS Pre-Programmed Dimming Module 104 system is shown in FIG. 3. Referencing FIG. 1, at the circuit board level, the GPS Pre-Programmed Dimming Module 104 can physically consist of a GPS Control Circuit Assembly 105, and the LED Power Supply Driver 102 can physically consist of a Power Supply Circuit Assembly 103. Note that the architecture of the GPS Pre-Programmed Dimming Module 104 system is not limited to that presented in FIG. 3 and other physical arrangements are possible.

Regarding the power supply for the GPS Pre-Programmed Dimming Module 104, the system includes a back-up power source supplied from the AC mains 302 that ensures that a central processing unit (CPU) 334 of the GPS Control Circuit Assembly 105 remains powered even if the control circuit has switched the main power to the streetlight OFF. This functionality allows the main power to the streetlight to be switched OFF during daylight hours, for example, while the CPU 334 continues to operate. The continued operation of the CPU 334 ensures that timing can be maintained, and the main power to the streetlight can be switched ON at the appropriate time, at sunset, or at whatever time is specified. When the main power to the streetlight has been switched OFF, and the CPU 334 is operating using the back-up power supply, the system energy usage can be very low and well within the requirements of Energy Star for a device in stand-by mode. Note that if the streetlight is used with a traditional Photo Control Switch that removes all power to the streetlight during daylight hours, the back-up power supply will not function during daylight hours and the CPU will not maintain timing. The GPS Pre-Programmed Dimming Module 104 control circuit will still function correctly to implement precise dimming during the night time hours in this case provided that the GPS Receiver 340 can determine geographic position after power up near sunset, which would be the normal case.

In the architecture drawing of FIG. 3, the CPU 334 of the GPS Control Circuit Assembly 105 communicates via a serial interface to a second CPU 318 that is part of the Power Supply Circuit Assembly both for controlling dimming levels and for ON/OFF switching of the main power supply to the streetlight. The CPU 318 is coupled to memory 319 providing instructions for controlling the dimming of LED modules 320 via a string controller 314. Dimming may be provided by individually enabling or disabling strings or LEDs in a defined pattern to ensure a desired lighting pattern is maintained. The power factor correction (PFC) power supply is supplied by the AC mains 302 providing a PFC output to the string controller 314. The CPU 318 and enable and disable the PDF supply 310, for example to turn off all power during daylight, and control individual strings or sets of LEDs via the string control 314. The exact methods used by the GPS Control Circuit Assembly 1058 to realize dimming and ON/OFF switching are not limited to the disclosure presented, and could be realized with a standard 0-10V Dimming Interface for example.

The control circuit of the GPS Pre-Programmed Dimming Module 104 includes CPU 334 that executes system software retrieved from memory 335. Whenever the streetlight Power Supply Circuit Assembly 105 is producing power for the streetlight, which is normally during the hours of darkness, the CPU 334 gathers GPS data from a GPS Receiver unit 340 via a serial electrical signalling interface provided by either on on-board or integrated antenna 342 or an external antenna 344. Provided that the GPS Receiver is able to determine its geographic location, the data set will include the geographic position (latitude and longitude) and Coordinated Universal Time (UTC).

When the CPU 334 receives Coordinated Universal Time from the GPS Receiver 340, and using pre-programmed knowledge of the Time Zone and Daylight Savings behavior of the region in which the streetlight operates, the CPU 334 is able to determine the real local time. The real local time is stored within the CPU 334 and is updated regularly from the GPS Receiver 340 to ensure that the system time is always accurate to within 5 minutes. In the unlikely case that a GPS signal is not available, the real local time will be maintained by a time-keeping function within the CPU for up to 30 days, if previously stored.

When the CPU 334 acquires the geographic location data and the Coordinated Universal Time from the GPS receiver 340, the CPU 334 can perform calculations using a solar calculation algorithm to determine the time of sunrise and sunset for the specific geographic location in which the streetlight is operating. The solar calculation algorithm is “accurate to within one (1) minute for locations between +/−72° latitude, and within ten (10) minutes outside of those latitudes” according to the National Oceanic and Atmospheric Administration (NOAA). Taking all sources of possible error into account, the accuracy of the sunset/sunrise calculation is expected to be well within fifteen (15) minutes under all conditions and at all locations, and is expected to be well under five (5) minutes at most geographic locations.

When the CPU has acquired knowledge of the real local time and of the local time of sunrise and sunset, the control circuit will perform three vital control tasks as follows:

1. It will turn the streetlight ON to a pre-programmed light output level at a pre-programmed offset time in relation to the time of sunset.

2. It will execute the pre-programmed daily dimming schedule that corresponds to the particular day of the week. Note that the daily dimming schedule consists of a data table that contains time-of-day information mapped to specific light output levels.

3. It will turn the streetlight OFF at a pre-programmed offset time in relation to the time of sunrise.

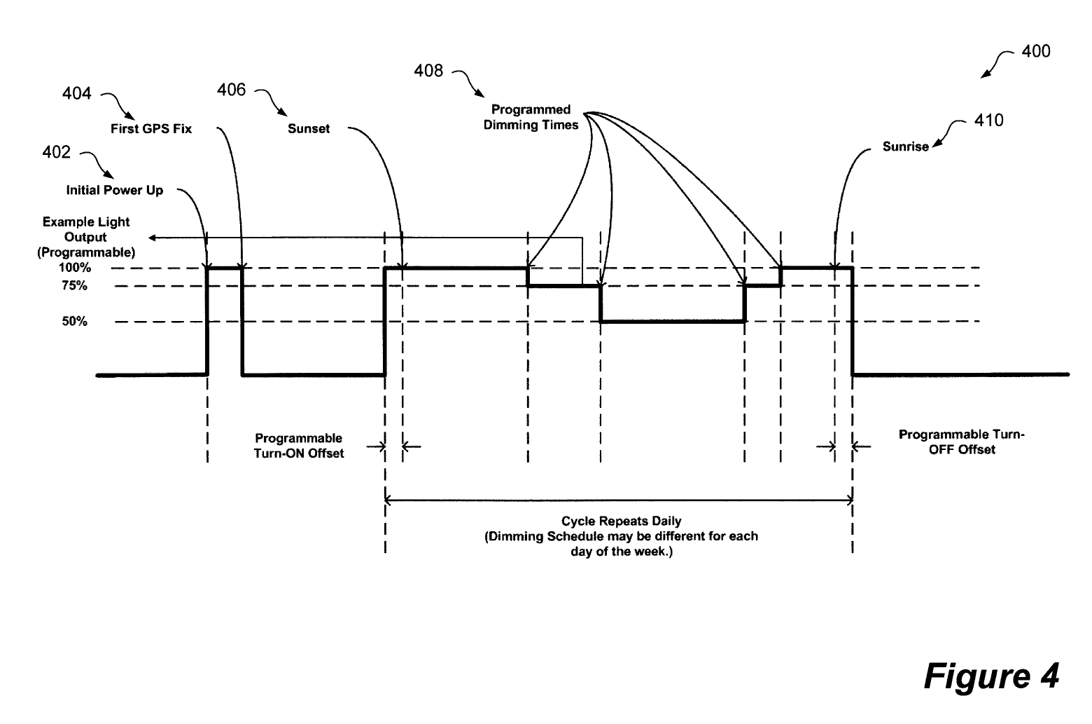

An illustration 400 of typical operation of the streetlight based on the functioning of the control circuit is provided in FIG. 4. During initial power up 402 the default setting may be to Turn-ON all LEDs lights for safety consideration during which time GPS fix is acquire. Once GPS fix is acquire, assuming it's during daylight hours, the LED modules 320 would be Turned-OFF. From the GPS data a sunrise and sunset time for the geographic location would then be determined. At Sunset 406 the CPU 334 or CPU 318 would determine that the LED modules 320 should be enabled and provide the appropriate signalling information to the string controller 314. Programming dimming times 408 can then be implemented during the night hours to decrease light output by enabling disabling LED modules 320, or alternatively varying voltage delivered to LED modules is segment dimming is not utilized. At Sunrise 410 the LED modules 320 would be Turned-OFF and power the PFC Supply 310 can be disable to conserve power.

Note that the streetlight Turn-ON may occur either before or after sunset based on a “Programmable Turn-ON Offset”. This offset time is normally “+10” meaning that the streetlight will Turn ON ten (10) minutes before the calculated sunset time. This offset allows compensation for factors such algorithm calculation errors, early darkness due to geographic location, or weather conditions. Similarly, a programmable offset pertains to the Turn-OFF of the streetlight near sunrise and is referred to as the “Programmable Turn-OFF Offset” with the difference being that streetlight Turn-OFF will generally occur slightly after sunrise.

It should be noted that the power supply CPU 318 may also be powered off with a single CPU 334 being utilized during daylight hours. Alternatively a single CPU may be utilized to implement GPS sunrise/sunset determination and dimming schedule based upon configuration.

A fail-safe mechanism can be built into the control circuit of the GPS Pre-Programmed Dimming Module 104. The fail-safe mechanism ensures that unsafe lighting conditions will not result due to an inability of the GPS Pre-Programmed Dimming Module to obtain valid GPS information (Geographic Position and Coordinated Universal Time) from the GPS Receiver. Specifically, the fail-safe mechanism serves to ensure that the streetlight stays ON at full light output, if GPS information is needed but cannot be acquired. The fail-safe would operate to keep the streetlight ON fully if (1) the GPS Receiver has not been able to acquire a geographic location since initial power-up of the system or (2) if an initial geographic position is obtained, but more than 30 days has passed without an update of the GPS data. By keeping the streetlight ON fully in the case of no acquisition of GPS information, the streetlight will operate at full brightness all day for maximum safety, and also operation of the streetlight during the daylight hours will serve to flag a problem to maintenance personnel. Note that an inability to acquire GPS information would occur primarily due to a hardware malfunction within the streetlight, which would be extremely rare. It is also possible that a GPS Receiver may not be able to calculate its geographic location due to extreme weather conditions or signal blockages due to snow and ice build-up on the streetlight, although the GPS system is very robust with respect to these factors.

The specific operation of the dimming is a function of the control circuit of the GPS Pre-Programmed Dimming Module 104. During this function, the control circuit determines the day of the week based on its real local time data that is derived from the GPS Receiver. With knowledge of the day of the week the control circuit executes a “daily dimming schedule” that corresponds to the specific day of the week. The daily dimming schedule consists of a data table that contains time-of-day information mapped to specific light output levels. Using the data table and the local real time, the control circuit can signal the streetlight power supply to switch to a specific light output level at a specific time of the day based on the data in the daily dimming schedule. In this manner, the control circuits works with pre-programmed configuration data, and information from a GPS Receiver 340 to realize a very precise dimming schedule for the streetlight. The GPS Pre-Programmed Dimming Module 104 supports the programming of a unique daily dimming schedule corresponding to each day of the week. A simplified version of the system will allow a single unique daily dimming schedule to be programmed for Monday through Thursday, and individual unique daily dimming schedules to be programmed for Friday, Saturday and Sunday. Note that the number of entries in the daily dimming schedule data table is only limited by the amount of data storage memory in the CPU, so that many light output level changes maybe realized throughout the night time hours. Approximately one hundred dimming schedule entries can be realized with approximately one thousand (1,000) bytes of data storage memory. The practical limit on data table entries will depend on the data storage memory of the CPU 334.

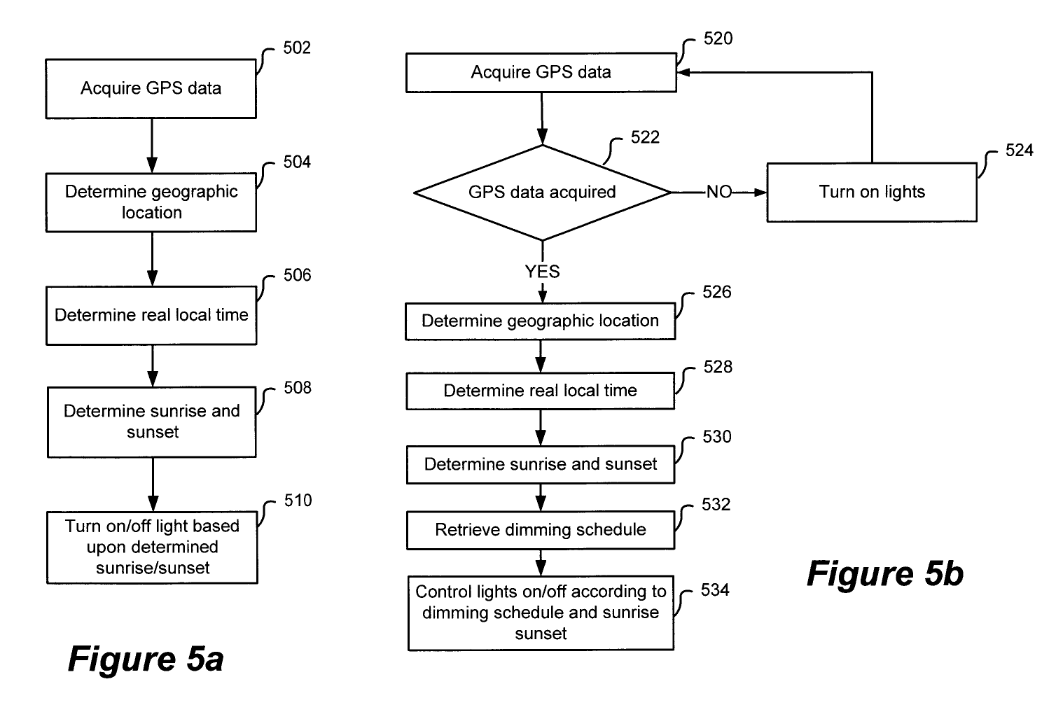

FIG. 5a shows a method of controlling and LED light using GPS programming. The GPS data is acquired (502) from a GPS receiver coupled to the LED light. The geographic location of the light is determined (504) from the GPS data and a real local time is determined (506) to account for daylight saving and GMT offset. From the real location time and associated location data a sunrise and sunset time can be determined (508). The LED modules can then be controlled, Turn-ON and Turn-OFF, based upon the sunrise and sunset times (510).

FIG. 5b shows a method of controlling and LED light using GPS programming and a dimming schedule. The GPS data is acquired (520) from a GPS receiver coupled to the LED light. If GPS data cannot be determined, (NO at 522) the lights may be turned on (524) by default. This may for example occur during start-up or due to receiver failure or obstruction of the receiver. Additional conditions may be applied that this stage if GPS data had been previously acquired and a confidence interval can be maintained with out addition GPS data being received. If GPS data is received (YES at 522) The geographic location of the light is determined (526) from the GPS data and a real local time is determined (526) to account for daylight saving and GMT offset. From the real location time and associated location data a sunrise and sunset time can be determined (530). A dimming schedule is retrieved (532) from local memory. The LED modules can then be controlled, Turn-ON and Turn-OFF, based upon the sunrise and sunset times (534) and the dimming schedule. When the dimming schedule is retrieved additional configuration parameters may be retrieved such as time offset or date specific consideration to be applied in the dimming schedule.

### Remote Communication Module

The Remote Communication Module 108 consists physically of an electronic component assembly that communicates electrically with the LED Power Supply Driver 102 and the GPS Pre-Programmed Dimming Module 104 as shown in FIG. 1. The nature of the communication enables the Remote Communication Module 108 to exert control over and to monitor the LED Power Supply Driver 102 and the GPS Pre-Programmed Dimming Module 104.

The purpose of the Remote Communication Module 108 is to enable the remote control and monitoring of a group of appropriately configured streetlights through the use of a remote control and monitoring system. The system described here is unique compared to other commercially available systems in part due to the incorporation of the GPS Pre-Programmed Dimming Module 104.

The data communications capability of the Remote Communication Module 108 may be realized with various wireless radio or power line carrier (PLC) signalling technologies. The communication system may be based on a relatively short-range communication link (such as radio operating in the unlicensed Industrial Scientific and Medical (ISM) bands or Wi-Fi) such that a base station in a vicinity of approximately 0.5 Km to 5 Km would allow for unique addressing of individual lights. Alternatively the communication link could implement Bluetooth radio for very short range communications of approximately 100 meters. For longer range wireless communications where infrastructure exists, it could be based on mobile or cellular technology such as CDMA, GSM, 3G such as HSPDA, LTE, or 4G. An option for world-wide coverage, in the absence of land-based infrastructure, is to base the Remote Communication Module on satellite signalling technology such as Iridium™. Another option for the Remote Communication Module is the implementation of a communication system based on power line carrier (PLC) technology. PLC technology uses the AC Mains infrastructure to physically realize electrical signalling for the purposes of data transfer. The communication range of PLC is typically in the range of 5-10 Km. This range can be extended with repeater systems, and is dependent on the nature of the AC Mains infrastructure. Note that for the purposes of this document, wireless radio operating in the ISM radio band and PLC communications will be considered as a typical case, although the system will be generalized as necessary to include the other possible communication options.

The Remote Communication Module may implement communication that is unique to the Remote Communication Module, or it may implement a communication standard such as that conforming to the IEEE 802.15.4 standard in the case of wireless radio for example.

The communication components can optionally include a mesh network capability. The mesh network capability can allow appropriately configured streetlights to automatically establish a communication network for the purposes of passing data messages to any member of the network. The mesh network will be self-forming and self-healing. Self-forming refers to a built in ability to automatically form a mesh network. Self-healing refers to a capability whereby the system can reconfigure itself in the case of the loss of a specific member of the mesh network, due to a malfunction of that member. The components of the system will optionally conform to a mesh networking standard such as Zigbee or IPv6 over Low power Wireless Personal Area Networks (6LoWPAN) in the case of wireless radio signalling.

### GPS-Based Autonomous Operation

As shown in FIG. 1, the Remote Communication Module forms a component of the overall control system. The system makes use of communication links, and especially in the case of wireless communications, the links may or may not be established at any given time based on the position of the base station in the case of base stations that are mobile. Because of this potential reliance on mobile wireless communications, it is important that the streetlights can perform all tasks autonomously.

To enable this autonomous streetlight operation with integration of communication links that may or may not be present, the system being described nominally integrates GPS technology into the Remote Communication Module of each streetlight.

The GPS technology is integrated into the functionality of each streetlight as a GPS Pre-Programmed Dimming Module as illustrated in FIG. 1. Conceptually, the GPS Pre-Programmed Dimming Module functions in association with the Remote Communication Module when the Remote Communication Module is present. Note however that at the physical circuit board level, the GPS Pre-Programmed Dimming Module and the Remote Communication Module may be very closely associated and the electrical components associated with each may be present on a common printed circuit board (PCB).

### Base Station Functionality

With the appropriate communications capability of the Remote Communication Module, it will be possible for control and monitoring data to be exchanged with any compatible device or base station. The compatible device or base station may be a Drive-By Wireless Base Station, a Hand-Held Wireless Base Station, a Web-Based Base Station, or another compatible device.

Regardless of the exact type of base station that is used as part of the overall system (FIG. 1) for the purposes of exchanging control and monitoring data, there are several key functionalities.

The purpose of the base station is to facilitate the transfer of control and monitoring data between a group of streetlights equipped with the Remote Communication Module and a Personal Computer (PC) that is operated by the administrator of that group of streetlights.

### Radio Format

The base station may implement radio communication that is unique to the radio communication of the compatible streetlight Remote Communication Module and is proprietary to LED Roadway Lighting. Alternatively it may implement a radio communication standard such as that conforming to the IEEE (Institute of Electrical and Electronics Engineers) 802.15.4 standard as appropriate for communication with compatible streetlight Remote Communication Modules.

The base station of the system will have the capability of sending data packets to the Remote Communication Module of each streetlight that contains configuration data. Such configuration data packets may affect the operation of the streetlight. For example, reception of a data packet may cause a streetlight to change its fixed light output level, or it may result in a change to when or if the streetlight executes a dimming schedule.

Note that dimming schedule data is one example of a configuration data packet. Another example is a data packet containing a coded version of the real local time and date. The base station can have the ability to request data packets from each streetlight that contains data of interest.

The Remote Communication Module of each streetlight can optionally have the ability to send regularly timed data packets that contain information about the status or system health of the specific streetlight. If the communication system includes a mesh network capability, it is possible to transfer control and monitoring data between the base station and any streetlight within a group of mesh networked streetlights, provided that communication is established with any streetlight that is a member of the mesh network.

Support automatic fault indication is provided, whereby if the Remote Communication Module of a streetlight has detected a problem or fault within the streetlight, it will automatically send data to indicate the problem. The automatic fault indication process will include a mechanism whereby the transfer of data that indicates the fault condition will occur at regular intervals. This mechanism will ensure that the data will be sent successfully eventually, in the case of intermittent communications with the base station, which is a typical case for a Drive-By Wireless Base Station for example. The base station will have the ability to reset the fault condition within the Remote Communication Module of the streetlight that has suffered the fault. Also, the base station will have the ability to permanently silence or disable of detection of the fault condition within the Remote Communication Module of the streetlight that has suffered the fault.

The use of a Personal Computer (PC) as a user interface is common and typical for all types of base stations that are being described. A portion of the control and monitoring data received by the Personal Computer (PC) will require transfer to another computer or computer system for storage and/or analysis.

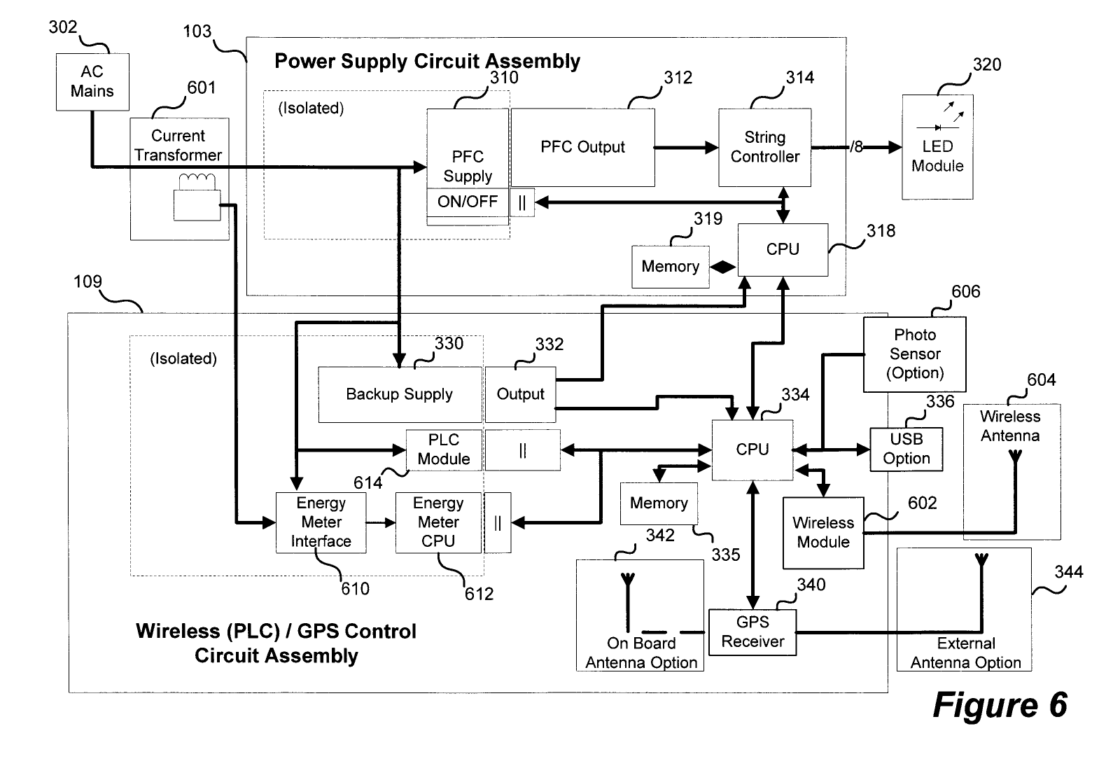

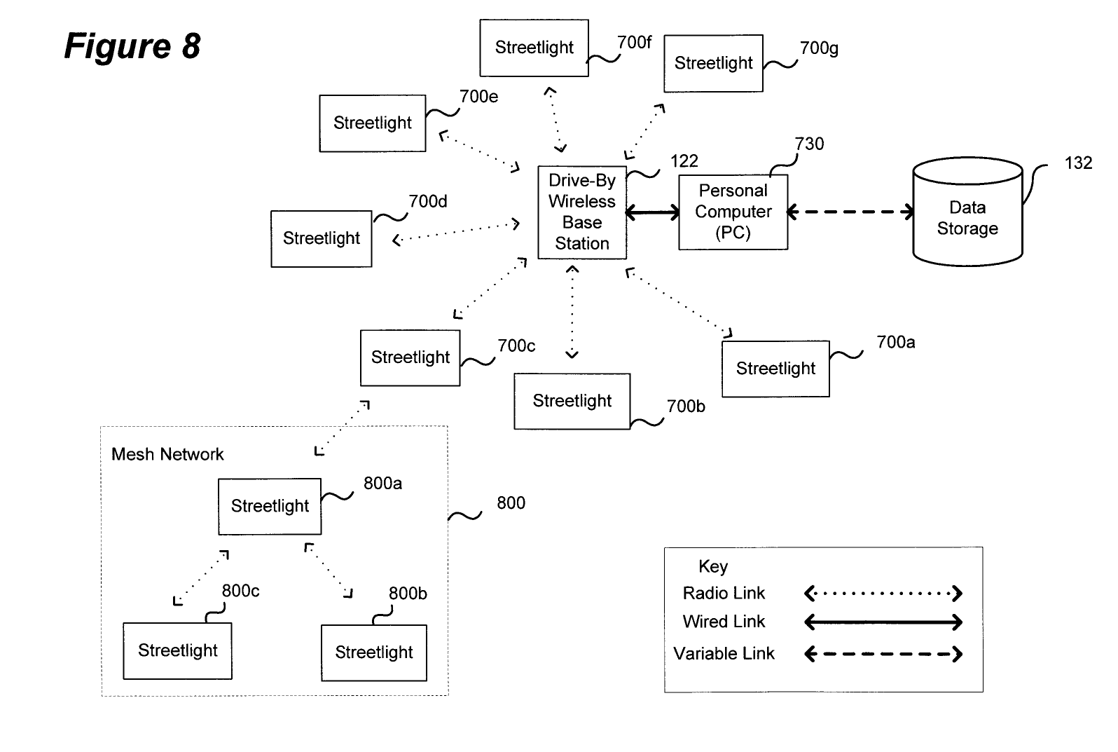

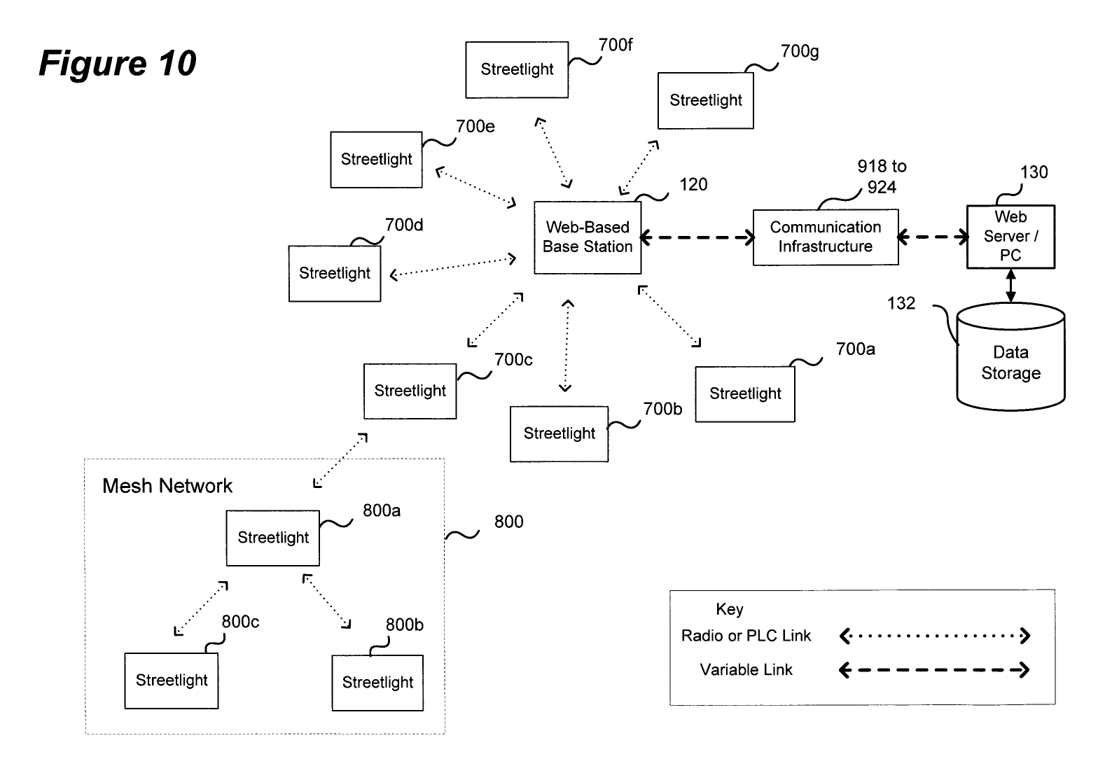

Based on the software application that it executes, and its hardware specifications the Personal Computer (PC) can have the ability to record data internally and it will also be able to transfer the data for storage or analysis by another computer or computer system as illustrated by the blocks labelled Data Storage and Analysis in FIG. 6, FIG. 8 and FIG. 10 which appear later in this document.

Architecture of the Remote Communication Module system is shown in FIG. 6. Referencing FIG. 1, at the conceptual circuit board level, the Remote Communication Module 108 can physically consist of a Wireless (PLC)/GPS Control Circuit Assembly 109, and the LED Power Supply Driver 102 will physically consist of a Power Supply Circuit Assembly 103. Note that the architecture of the Remote Communication Module system is not limited to that presented in FIG. 5 and other physical arrangements are possible.

As shown in FIG. 6, the architecture is very similar to that of the GPS Pre-Programmed Dimming Module 104. As with the GPS Pre-Programmed Dimming Module 104 architecture of FIG. 3, a Back-Up Power Supply 330 is implemented, which provides uninterrupted power to the system Central Processor Units 318 and 334. The Remote Communication Module 108 differs from the GPS Pre-Programmed Dimming Module 104 in that communication modules (shown as Wireless Module 602 and PLC Module 614 in FIG. 6) are added and an energy metering system 614 is added.

The Wireless Module 602 block shown in FIG. 6 enables radio communications with other compatible radio devices for the purposes of transferring control and monitoring data between the CPU of the Wireless (PLC)/GPS Control Circuit Assembly. If a PLC module 614 is utilized the wireless module and associated hardware may not be included and vice versa. The wireless module 602 is coupled to a wireless antenna 604 which may be separate from GPS antennas 342 and 344 or integrated therein. The wireless module 602 communicates with the CPU 334 to send/receive data for programming of the Wireless (PLC)/GPS Control Circuit Assembly 109. A photo sensor 606 may also be provided and coupled to the CPU 334 to over ride the light triggering times based upon additional external lighting factors.

The energy metering system, consisting of the Energy Meter Interface 610 and the Energy Meter CPU 612, as shown in FIG. 6 serves to accurately measure the energy usage of the entire streetlight.

In the architecture drawing of FIG. 6, the CPU 334 of the Wireless (PLC)/GPS Control Circuit Assembly communicates via a serial interface to a second CPU 318 that is part of the Power Supply Circuit Assembly 103 both for controlling dimming levels and for ON/OFF switching of the main power supply to the streetlight. The exact methods used by the Wireless (PLC)/GPS Control Circuit Assembly to realize dimming and ON/OFF switching are not limited to the concept presented, and could be realized with a standard 0-10V Dimming Interface for example.

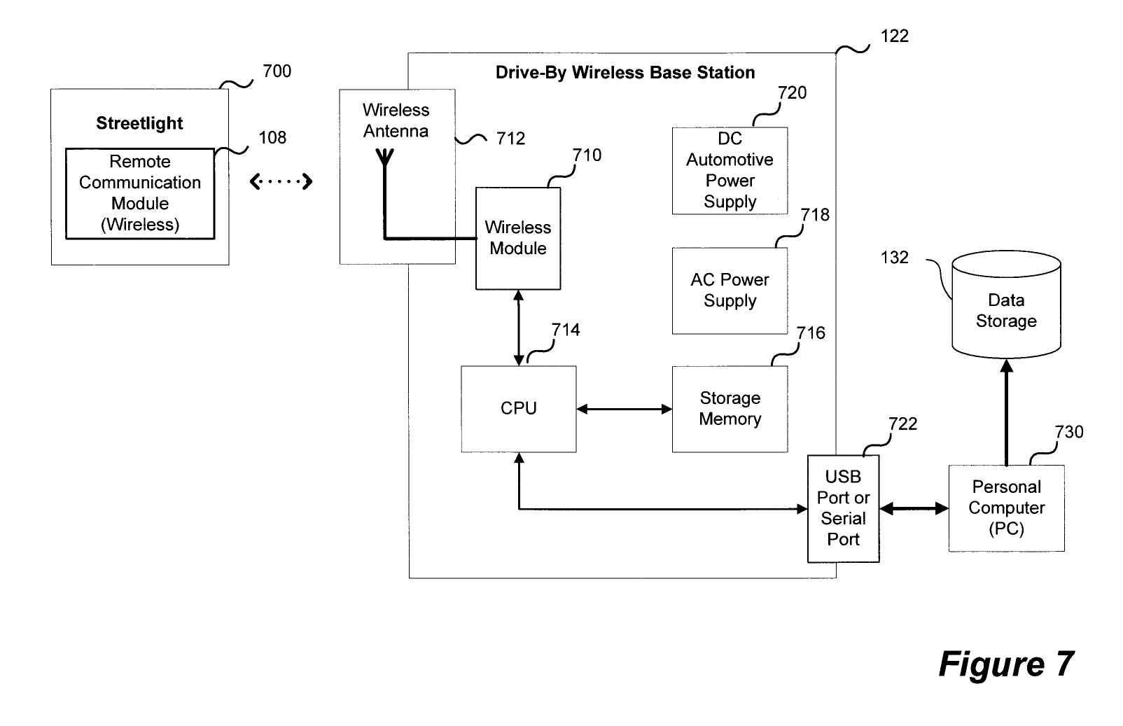

A block diagram for the Drive-By Wireless Base Station is provided as FIG. 7. The Drive-By Wireless Base Station 122 forms an element of the Overall System Block Diagram provided as FIG. 1. Physically, the Drive-By Wireless Base Station 122 is built into an assembly that is fully mobile. With this mobility, the unit may be used in conjunction with any type of mobile transportation vehicle such as a car, a truck or even a slow moving aircraft such as a helicopter. The mobile nature of the unit allows it to be transported within radio communication range of a streetlight or a group of streetlights. Because the unit may be moved as required, it is possible to communicate with any number of streetlights provided that it is possible to move the unit within the radio range of those streetlights. This capability contrasts with a system that uses base stations that are positioned at fixed locations in that typically many base stations are required to facilitate access to a large group of streetlights in that case. The ability to use a single Drive-By Wireless Base Station 122 to access or send data to a group of streetlights with an unlimited number of members allows a reduction in infrastructure cost and complexity.

In a typical usage of the Drive-By Wireless Base Station 122, the unit is integrated into a service vehicle such as a system maintenance vehicle. As the service vehicle drives within radio range of each streetlight, control and monitoring data is transmitted to the Remote Communication Module 108 of that streetlight 700, and monitoring data is received from the Remote Communication Module 108 of that streetlight 700. The communication process is automated so that the data transfer to and from the streetlights within radio range occurs as the vehicle drives normally, and can be configured to occur without operator intervention. Drive-By Wireless Base Station 122 comprises a wireless module 710 coupled to a wireless antenna 712. A CPU 714 is coupled to a storage memory 716 for storing data and software received from/sent via the wireless module 710 to the streetlight 700. The Drive-By Wireless Base Station 122 may also be provided with a USB or serial port or other local area communications interface 722 to upload or download data from a personal computer 730, or network, or server, to store data retrieved from the street lights for analysis 132. A DC automotive power supply interface 720 or AC power supply interface 718 may be provided.

An illustration of the network architecture for the Drive-By Wireless Base Station system is shown in FIG. 8. The Drive-By Wireless Base Station 122 has the ability to record data internally as illustrated by the block labelled Storage Memory 716 in FIG. 7. Also the Drive-By Wireless Base Station has the ability to upload the data to a Personal Computer (PC) 730 via a USB (Universal Serial Bus) or other standard communication link. The host computer will execute the software application that provides the operator user interface. The Drive-By Wireless Base Station 122 communicates with Streetlights 700a to 700f by wireless communication when in the proximity. It is assumed that the radio frequency range of the streetlight wireless module is designed to limit interference with nearby streetlight wireless interface either by known wireless access protocols, address assignment or frequency assignments. In the case of mesh network 800, multiple streetlights 800a to 800c may communicate with a single streetlight 700c which can in-turn send and receive data for the group of lights 800, eliminating the direct requirement for communication with each individual light.

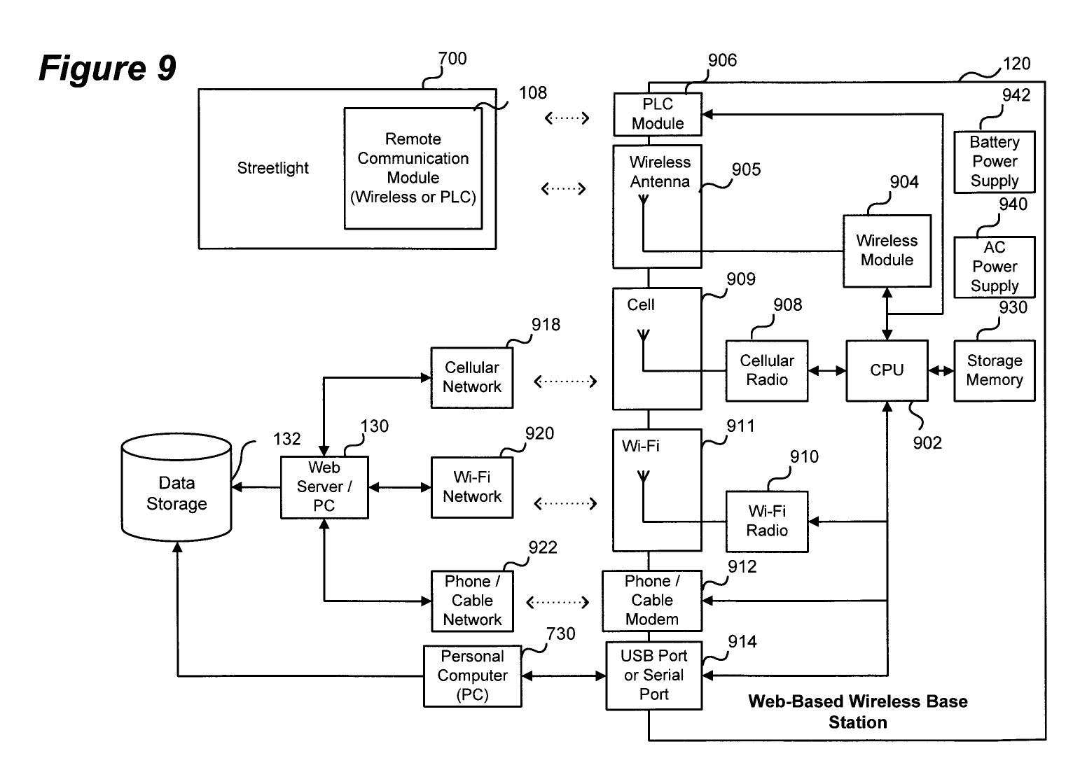

A block diagram for the Web-Based Base Station 120 is provided as FIG. 9. The Web-Based Base Station 120 forms an element of the Overall System Block Diagram provided as FIG. 1. The purpose of the Web-Based Base Station 120is to facilitate the transfer of control and monitoring data between groups of streetlights equipped with the Remote Communication Module 108 and a Personal Computer (PC) that is operated by the administrator of that group of streetlights. To perform this function, the Web-Based Base Station 120 must, by virtue of its hardware and software functionality, be compatible with the Remote Communication Module 108 of each streetlight and it must be able to send data to, and receive data from, the Internet (sometimes referred to as the World Wide Web).

Physically, the Web-Based Base Station 122 typically consists of an integrated assembly that is mounted to a suitable radio tower (or PLC access point as appropriate) in a carefully selected geographical location. The geographical location is selected so that it is within radio range (or PLC range as appropriate) of a group of streetlights, each incorporating the Remote Communication Module 108. Also the geographical location is selected so that there will be access to the Internet through the use of cellular, Wi-Fi or phone/cable modem technology. The unit will be designed and built to withstand the outdoor environment in which it operates.

Because the unit is mounted in a fixed geographical location, the unit will be able to relay control and monitoring data to only the compatible streetlights that are positioned geographically within its radio range or in the case that a mesh network capability, the unit will be able to relay data to and from any streetlight that is a member of the mesh network, provided that at least one member of the network is with radio range.

In a typical usage of the Web-Based Base Station, the entire streetlight communication system will be used to control and monitor a group of streetlights from a remote and typically fixed location. Remote control may involve sending configuration data to each streetlight, as well as sending commands that affect the ON/OFF state or the light output level state of the streetlights. Streetlight performance may be monitored based on the control and monitoring data described. The data transfer may be automated through the use of sophisticated host application software or it may be manual or in other words based on human user intervention.

The host application software will typically be created as web-based software stored in memory 930 and executed by CPU 902, meaning that it can be executed and controlled remotely by any Personal Computer (PC) that can connect to the Internet, and meets the appropriate minimum system requirements. The CPU 902 may interface with one or more communication interface such as PLC module 906, wireless module 904 coupled to antenna 905 to send or receive information from streetlight 700. The CPU 902 may also couple to cellular radio module 908 coupled to cellular antenna 909 and a cellular or broadband communication network 918, Wi-Fi radio module 910 coupled to Wi-Fi antenna 911 and Wi-Fi network 920, phone or cable model 910 coupled to phone/cable network 922 or USB Port or Serial Port 914 coupled to a personal computer 730 to in-turn communication with web/server PC 130.

An illustration of the network architecture for the Web-Based Base Station system is shown in FIG. 10. The Web-Based Base Station has the ability to record data internally as illustrated by the block labelled Storage Memory 930 in FIG. 9. For the transfer of data to and from the Internet, the Web-Based Base Station will optionally include various standard technologies to facilitate the access. For example, as illustrated in FIG. 9 above, a cellular radio module or a Wi-Fi radio module may be implemented to facilitate wireless access to the Internet. Alternatively a phone or cable modem may be used to facilitate the Internet access. Note that for all of these standard technologies that may be used to access the Internet, some infrastructure external to the Web-Based Base Station 120 is required.

The Web-Based Base Station 120 has the ability to record data internally as illustrated by the block labelled Storage Memory 930 in FIG. 9. The Web-Based Base Station 120 communicates with Streetlights 700a to 700f by wireless communication or PLC. In the case of mesh network 800, multiple streetlights 800a to 800c may communicate with a single streetlight 700c which can in-turn send and receive data for the group of lights 800, eliminating the direct requirement for communication with each individual light. The use of this technology for accessing the Internet may involve a recurring usage charge that must be paid to a service provider. Also the infrastructure provided by the service provider may become a critical link in the system and this fact leads to an advantage of having a GPS receiver integrated into the Remote Communication Module 108 of each streetlight. The integration of a GPS receiver allows the Remote Communication Module to correctly and reliably control the accurate real-local-time-based dimming of the streetlight, independently of the reliability of a wireless control system involving a Web-Based Base Station 120.

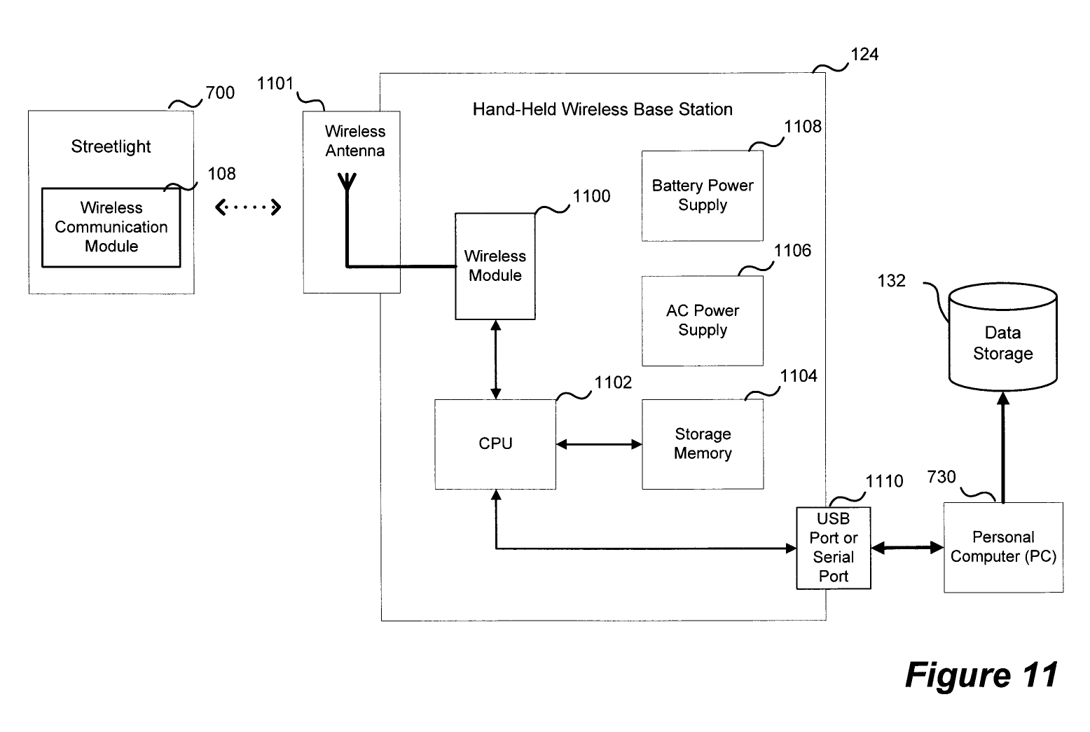

A block diagram for the Hand-Held Wireless Base Station 124 is provided as FIG. 11. The Hand-Held Wireless Base Station 124 forms an element of the Overall System Block Diagram provided as FIG. 1. Physically, the Hand-Held Wireless Base Station 124 is integrated into a hand-held wireless communication device, such as a Personal Digital Assistant (PDA), a cellular phone, or another hand-held communication device, that is compatible with the Remote Communication Module of the streetlight. The Hand-Held Wireless Base Station 124 will typically be a small portable device that can be hand-held by a qualified user and is fully portable and capable of battery powered operation. The hand-held portable nature of the unit allows it to be transported easily by a single person within radio communication range of a streetlight or a group of streetlights. Because the unit may be moved as required, it is possible to communicate with any number of streetlights provided that it is possible to move the unit within the radio range of those streetlights. This capability contrasts with a system that uses base stations that are positioned at fixed locations in that typically may base stations are required to facilitate access to a large group of streetlights in the case of fixed base station locations. The ability to use a single Hand-Held Wireless Base Station 124 to access or send data to a group of streetlights with an unlimited number of members allows a reduction in infrastructure cost and complexity.

In a typical usage of the Hand-Held Wireless Base Station 124, the unit is carried by hand within radio communication range of each streetlight that requires an exchange of control and monitoring data. The system can be configured so that as the operator enters within the radio range of each streetlight, control and monitoring data is transmitted to the Remote Communication Module 108 of that streetlight, and monitoring data is received from the Remote Communication Module of that streetlight. The communication process can be automated so that the data transfer to and from the streetlights within radio range occurs as the operator moves within radio range, and can be configured to occur without operator intervention.

The Hand-Held Wireless Base Station 124 comprises a wireless module 1100 coupled to a wireless antenna 1101. A CPU 1102 is coupled to a storage memory 1104 for storing data and software received from/sent via the wireless module 1100 to the streetlight 700. The Hand-Held Wireless Base Station 124 may also be provided with a USB or serial port or other local area communications interface 1110 to upload or download data from a personal computer 730, or network, or server, to store data retrieved from the street lights for analysis 132. A battery power supply interface 1108 or AC power supply interface 1106 may be provided.

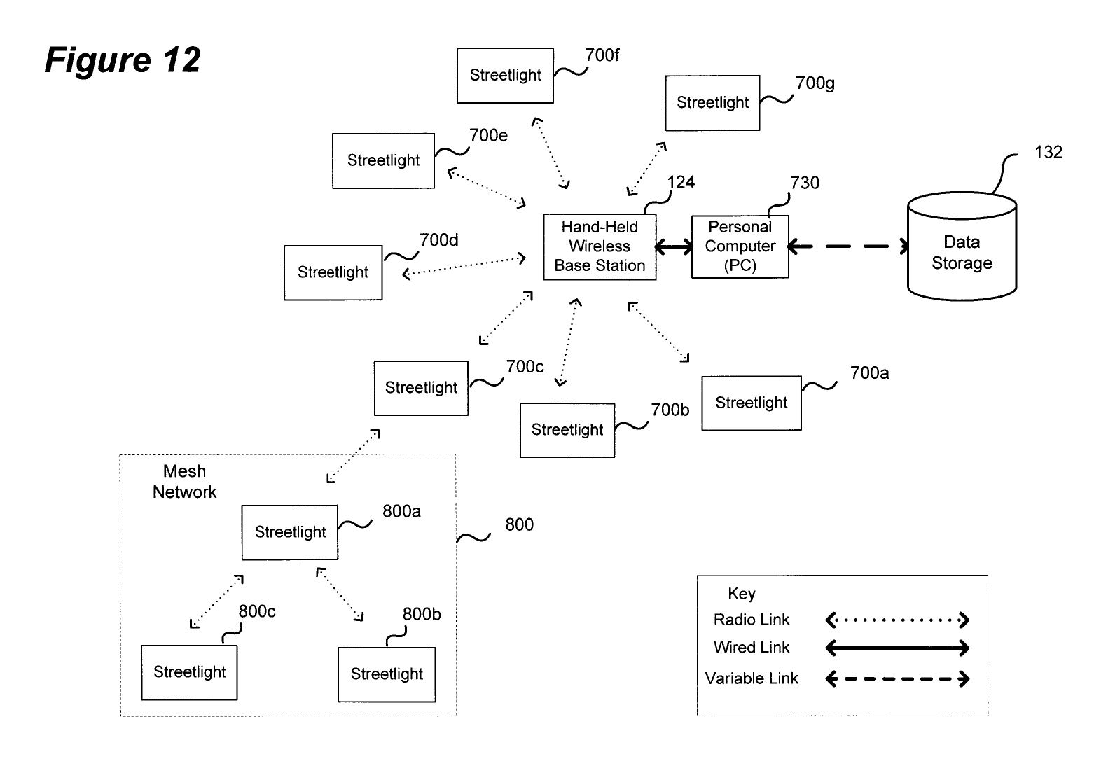

An illustration of the network architecture for the Hand-Held Wireless Base Station 124 system is shown in FIG. 12. The Hand-Held Wireless Base Station 124 has the ability to record data internally as illustrated by the block labelled Storage Memory 1104 in FIG. 11. Also the Hand-Held Wireless Base Station 124 has the ability to upload the data to a Personal Computer (PC) via a USB (Universal Serial Bus) or other standard communication link. The host computer will execute the software application that provides the operator user interface. The Hand-Held Wireless Base Station 124 has the ability to record data internally as illustrated by the block labelled Storage Memory 1104 in FIG. 11. The Hand-Held Wireless Base Station 124 communicates with Streetlights 700a to 700f by wireless communication or PLC. In the case of mesh network 800, multiple streetlights 800a to 800c may communicate with a single streetlight 700c which can in-turn send and receive data for the group of lights 800, eliminating the direct requirement for communication with each individual light. The integration of a GPS receiver allows the Remote Communication Module 108 to correctly and reliably control the accurate real-local-time-based dimming of the streetlight, independently of the reliability of a wireless control system involving a Hand-Held Wireless Base Station 124.

### Control and Monitoring Overview

The overall communication system implemented will facilitate the exchange of data packets between a user interface that is typically executed by a Personal Computer (PC) and a streetlight incorporating a Remote Communication Module. This exchange of data will enable remote control of each streetlight in the system from the user interface (Personal Computer (PC)). It will also enable data that may be present within each streetlight to be gathered and analyzed.

### Data Protocol

The communication link between the Remote Communication Module and the base station will be enabled through the use of an appropriate communication module.

At the signalling level, the communication may be proprietary or it may conform to a standard such as the IEEE 802.15.4 standard or similar standards. In either case, the signalling technology will support the transmission of binary data. The binary data sent by the base station will be decoded by the CPU of the Remote Communication Module at the streetlight end of the radio link. Similarly, binary data sent by the Remote Communication Module will be decoded by the CPU of the base station at the base station end of the radio link. The binary data is formatted with a protocol that is appropriate for the nature of the data being transferred and the signalling technology.

### Control Messages and Response Messages

Control Messages are defined as data packets that are sent by the base station to the Remote Communication Module of the streetlight. Response Messages are defined as data packets that are sent by the Remote Communication Module of the streetlight to the base station in response to Control Messages.

Typically, Control Messages transmitted from the base station to the Remote Communication Module consists of ON/OFF commands, dimming level commands, configuration setting commands, dimming schedule commands, special function commands, and software update commands.

Table 1 below lists Control Message Names. Note that each Control Message will have a corresponding Response Message that is not listed.

TABLE 1
Control Messages

| Control Message | |
|---|---|
| Name | Description |
| ON/OFF | Command causes the streetlight light output to be |
| Command | turned ON and OFF. |
| Dimming Level | Command causes the streetlight to adjust the level of |
| Command | its light output (dim). |
| Set Configuration | Command causes the Remote Communications |
| Settings | Module to store the configuration settings that are part |
| Command | of the command. |
| Set Dimming | Command causes the Remote Communications |
| Schedule | Module to store the dimming schedule that is part of |
| Command | the command. |
| Perform Special | Command causes the Remote Communications |
| Function | Module to perform a specific special function. This |
| Command | could involve special the generation of special lighting |
| | patterns in emergency situations. Also it could involve |
| | the control of auxiliary equipment such as an external |
| | Motion Sensor. |
| Initiate Software | Command causes the Remote Communications |
| Update Command | Module to configure for software update. |

Table 2 below contains a list of important data that will nominally be monitored by the streetlight. Typically the base station will routinely gather all or a subset of this data from all streetlights within the system. To do so, the base station will send appropriate control messages to the Remote Communication Module requesting specific data packets that contain the data of interest.

Alternatively, the Remote Communication Module of each streetlight may be configured to send specific data packets at a pre-programmed time interval. It will also be possible to enable a capability of the Remote Communication Module whereby specific data packets containing fault (or error) indications will be sent by the Remote Communication Module at a pre-programmed time interval only if a fault (or error) has been detected within the streetlight.

TABLE 2
Monitoring Data

| Monitoring Data Name | Description (Units) |
|---|---|
| Streetlight Fault Status | List of conditions that will result in |
| Streetlight Failure | warnings, alarms, alerts or failures |
| Streetlight Cycling | |
| Streetlight Day Burning | |
| Low Power Factor | |
| AC Mains Brownout | |
| Incorrect Power Level | |
| Time of Power Failure | |
| Power Up Time | |
| Power Loss Events | |
| Ground Fault Events | |
| Self-Test Errors/Faults | |
| System Status Indications | |
| Running Hours | Accumulated Hours of Operation (Hours) |
| Energy | Accumulated measurement of energy |
| | (Kilowatt -Hours) |
| Power | Power Consumption (Watts) |
| Power Factor | (Unit-less Ratio) |
| AC Mains Voltage | Average AC Mains Voltage (Volts RMS) |
| AC Mains Current | Average AC Mains Current (Amperes |
| | RMS) |
| LED Power Supply Driver | (DC Volts) |
| Voltage | |
| LED Power Supply Driver | Average DC LED Power Supply Current |
| Current | (DC Amperes) |
| LED Power Supply Driver | (Degrees Celsius) |
| Temperature | |
| LED Temperature | (Degrees Celsius) |
| GPS Position | Geographic Position (Latitude and |
| | Longitude) |
| GPS Status | Status Data (Number of Satellites, |
| | Position Fix Status, Fault Conditions, |
| | Signal to Noise Levels) |
| Real Time Clock Value | Real Time based on data from GPS |
| | module |
| Sensor Data | |
| Motion Sensor Input | |
| Photo Sensor Input | |
| General Purpose Inputs/ | |
| Outputs | |
| Switched AC output from a | |
| standard Photo Control | |

The Remote Communication Module will have on-board data storage capability and will optionally record historical data as appropriate. Historical data may include Streetlight Fault Status, Energy, Power, Power Factor, AC Mains Voltage, AC Mains Current, LED Power Supply Driver Voltage, LED Power Supply Driver Current, LED Power Supply Driver Temperature, LED Temperature and GPS Status.

It will be possible for the base station to request that a specific Remote Communication Module sends all of its recorded historical data for storage and analysis at the base station.

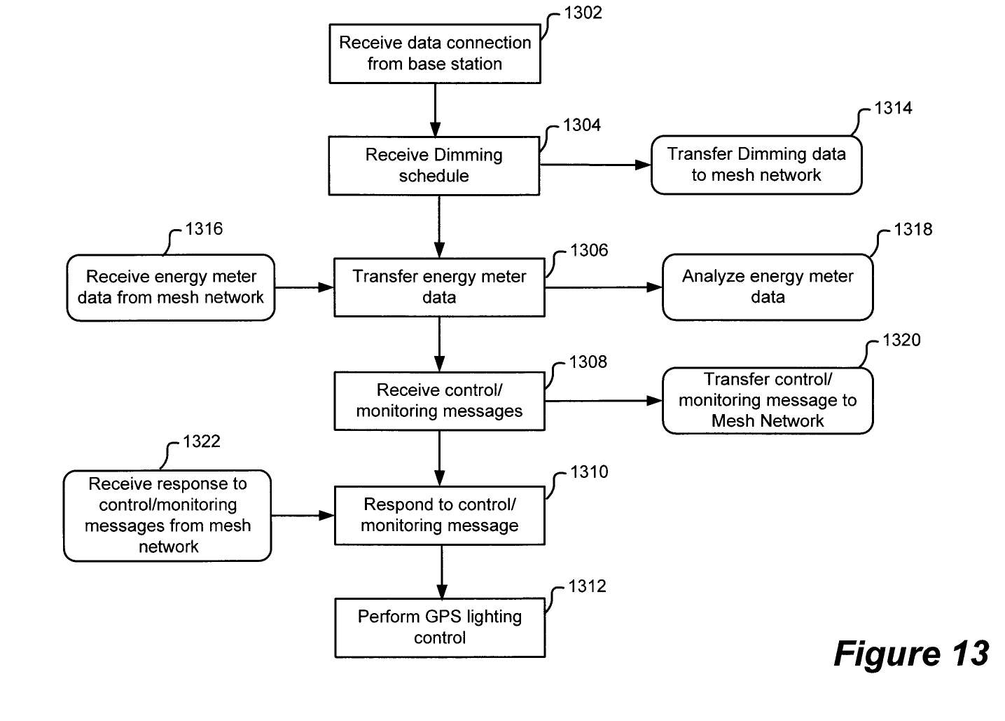

FIG. 13 is a method of Remote communication. A data connection is received (1302) or established with a base station 120, 122, 124 through a communication interface disclosed above provided by Remote Communication Module 108. A dimming schedule can be uploaded to the streetlight 700 (1304). In a mesh network configuration the schedule may be transferred (1314) to other lights within the mesh. Energy meter data may be transferred (1306) to the network for analysis (1318) performed externally. In a mesh network configuration the light may receive or collect energy meter data from other lights (1316) and provide all the data to the base station. Control and monitoring message and also be received (1308) from the base station and again, they may be transferred to other lights in the network (1320). Responses or confirmation can be received from lights in the mesh (1322) and/or a response provided by the light 700 (1310). It should be noted that the control and monitoring message may include the dimming schedule and energy metering data or they may be unique function call to the light. The streetlight can then implement GPS lighting control (1312) as described in connection with FIG. 5.

The term streetlight is used in the disclosure it should be understood the disclosure is equally applicable to any outdoor light to illuminate outdoor areas such as roadways, parks, parking lots, buildings, walkways, parkways, highways and other public areas. Although the above discloses GPS-based streetlight wireless command and control system, it should be noted that such configurations are merely illustrative and should not be considered as limiting as other variations may be contemplated without venturing away from the intent of the disclosure. Accordingly, while the following describes example construction, persons having ordinary skill in the art will readily appreciate that the examples provided are not the only way to implement such streetlight command and control system. The embodiments described above are intended to be illustrative only. The scope of the invention is therefore intended to be limited solely by the scope of the appended claims.

1. A method for controlling a light emitting diode (LED) streetlight comprising:
acquiring global positioning system (GPS) data from a GPS coupled to a processor of the streetlight;
determining in the processor a geographic location of the streetlight from the received GPS data;
determining in the processor a real local time from the GPS data;
determining in the processor a sunrise and sunset time associated with the geographic location; and
controlling an on and off state of one or more LED lighting modules of the streetlight based upon the determined sunrise and sunset times and the real local time.

2. The method of claim 1 wherein if GPS data is not acquired the one or more LED lighting modules are turned on by default until valid GPS data is acquired.

3. The method of claim 1 further comprising retrieving a dimming schedule, the dimming schedule applied in conjunction with the determined sunrise and sunset times to determine the on and off state of one or more LED lighting modules.

4. The method of claim 3 further comprising retrieving one or more offset times, the one or more offset times applied to the sunrise or sunset times.

5. The method of claim 3 further comprising receiving control messages from a wireless base station.

6. The method of claim 5 further comprising receiving a dimming schedule through a communication interface from the wireless base station.

7. The method of claim 3 further comprising sending energy meter data through a communication interface to the wireless base station.

8. The method of claim 7 wherein the communication with one or more streetlight by a mesh network comprising a plurality of LED streetlights to send and receive control or monitoring data to the wireless base station.

9. A light emitting diode (LED) streetlight controller comprising:
a global positioning system (GPS) dimming module comprising:
a GPS receiver;
a processor coupled to the GPS receiver for acquiring GPS data from the GPS received determining in the processor a geographic location and a real local time from the GPS data to determine a sunrise and sunset time associated with the geographic location;
a LED control interface for controlling an on and off state of one or more LED lighting modules of the streetlight based upon the determined sunrise and sunset times and the real local time.

10. The streetlight controller of claim 9 wherein the processor further uses a dimming schedule applied in conjunction with the determined sunrise and sunset times to determine the on and off state of one or more LED lighting modules through the LED control interface.

11. The streetlight controller of claim 10 wherein the processor further uses one or more offset times, the offset times applied to the sunrise or sunset times.

12. The streetlight controller of claim 11 further comprising:
a remote communication module for communicating with a base station to send and receive control information.

13. The street light controller of claim 12 further comprising an energy meter processor and an energy meter interface for providing energy meter usage to the base station.

14. The streetlight controller of claim 12 further comprising receiving a dimming schedule through the remote communication interface from the wireless base station.

15. The streetlight controller of claim 13 wherein the remove communication module uses a wireless communication interface or a power-line communication interface to communicate with the base station.

16. (canceled)

17. The streetlight controller of claim 15 further comprising a photo sensor for overriding the on and off state of the one or more LED lighting modules.

18. The streetlight controller of claim 12 wherein the base station is selected from the group comprising: a web-base controller, a handled controller, or a vehicle base controller.

19. The streetlight controller of claim 18 wherein the remote communication module provides data using IEEE 802.15.4 protocol.

20. The streetlight controller of claim 15 wherein the remote communication module provides mesh network communication with one or more streetlights within proximity of each other.

21. The method of claim 5 wherein the wireless base station is a hand-held wireless base-station, wherein the handheld wireless base-station communicates with the streetlight when in wireless range to provide the dimming schedule.

22. The method of claim 5 further comprising using a photo sensor for overriding the on and off state of the one or more LED lighting modules as defined by the determined sunrise and sunset times.

23. The method of claim 3 wherein the dimming schedule is retrieved from a memory coupled to the processor.
